(19) United States
(12) Patent Application Publication
(10) Pub. No.: US 2020/0088343 A1
(43) Pub. Date: Mar. 19, 2020

(54) A FOLDABLE SUPPORT ASSEMBLY AND METHOD OF MANUFACTURING THE SAME

(71) Applicants: Gek Duan Dean Neo, Singapore (SG); Minh Minh Nguyen, Singapore (SG)

(72) Inventor: Minh Hieu Nguyen, Singapore (SG)

(21) Appl. No.: 16/470,840

(22) PCT Filed: Jan. 10, 2018
(86) PCT No.: PCT/SG2018/050013

§ 371 Date: Jun. 18, 2019

(30) Foreign Application Priority Data
Jan. 12, 2017 (SG) 10201700275W

(51) Int. Cl. F16M 11/38; F16M 11/16

(52) U.S. Cl. CPC F16M 11/38; F16M 11/16

(57) ABSTRACT

The foldable support assembly includes a polygonal shaft and a plurality of legs arranged around the shaft. Each of the plurality of legs has a proximal end and a distal end, and a cross-sectional profile complementary to a cross-sectional profile of the shaft. The foldable support assembly also includes a pivot system connecting the proximal end of each of the plurality of legs to the shaft, such that each leg is rotatable about an axis perpendicular to a corresponding side surface of the shaft to operate the assembly between a first configuration wherein the distal end of said leg is adjacent the shaft and a second configuration wherein the distal end of said leg extends outwardly from the shaft.

### TECHNICAL FIELD

The present invention generally relates to a foldable support assembly and method of manufacturing the same.

### BACKGROUND ART

Support assemblies are often used as platforms to support the weight and to maintain the stability of objects that are mounted onto the platforms. A conventional support assembly provides stability against downward and lateral forces while restricting movement relative to a bearing surface upon which the support assembly rests. In a typical operating scenario, the legs of a conventional support assembly are generally positioned away from the vertical axis of the body of the support assembly to provide support against lateral forces, e.g. toppling moments. Conversely, in a typical storage scenario, the legs of the support assembly are either detached from the body or brought close to the vertical axis to reduce spatial requirements.

Some specific examples of support assemblies are tripods which may come in different forms. Tripods that are adapted for travel are usually foldable to reduce storage bulk. However, the trade-offs are that they either may not have the required stability or rigidity, or may not be sufficiently light and compact. Some tripods have complicated mechanisms to operate and secure the legs.

Clearly, the characteristics required of support assemblies in the operating scenario conflict with those required in the storage scenario. Hence, what is needed is a support assembly that seeks to reconcile the contradictory requirements. Furthermore, other desirable features and characteristics will become apparent from the subsequent detailed description and the appended claims, taken in conjunction with the accompanying drawings and this background of the disclosure.

### SUMMARY OF INVENTION

A first aspect of the present invention provides a foldable support assembly. The foldable support assembly comprises a polygonal shaft and a plurality of legs arranged around the shaft. Each of the plurality of legs comprises a proximal end and a distal end, and a cross-sectional profile complementary to a cross-sectional profile of the shaft. The foldable support assembly also comprises a pivot system connecting the proximal end of each of the plurality of legs to the shaft, such that each leg is rotatable about an axis perpendicular to a corresponding side surface of the shaft to operate the assembly between a first configuration wherein the distal end of said leg is adjacent the shaft and a second configuration wherein the distal end of said leg extends outwardly from the shaft.

The cross-sectional profile of each leg may comprise a long edge and a short edge corresponding to a major surface and a minor surface of the leg, and wherein the major and the minor surfaces define a notch for rotationally stopping the leg at a fully extended position.

The distal end of each leg may comprise a bevelled face configured to contact a supporting surface at the fully extended position.

The shaft may be substantially perpendicular to the support surface at the fully extended position.

The corresponding side surface of the shaft may comprise first and second edges, and the minor surface is adjacent the first edge in the first configuration and the notch abuts the second edge at the fully extended position.

The pivot system may comprise a plurality of hinge pins, and each hinge pin connects the major surface of each leg to the corresponding side surface of the shaft.

The plurality of legs may be simultaneously operable between the first and the second configurations. The foldable support assembly may further comprise a gear mechanism configured to simultaneously operate the legs between the first and the second configurations.

The gear mechanism may be connected to an electric motor.

The gear mechanism may further comprise a ratchet configured to rotationally stop the legs at a predetermined angle relative to the shaft.

The assembly may comprise a tripod, wherein the shaft comprises a triangular tube, and wherein each leg comprises a V-shaped cross-sectional profile.

A second aspect of the present invention provides a method of manufacturing a foldable support assembly. The method comprises providing a polygonal shaft and providing a plurality of legs, each of the plurality of legs comprising a proximal end and a distal end, and a cross-sectional profile complementary to a cross-sectional profile of the shaft. The method also comprises connecting the proximal end of each of the plurality of legs to the shaft, such that each leg is rotatable about an axis perpendicular to a corresponding side surface of the shaft, the assembly thereby being operable between a first configuration wherein the distal end of said leg is adjacent the shaft and a second configuration wherein the distal end of said leg extends outwardly from the shaft.

The method may comprise forming the plurality of legs such that the cross-sectional profile of each leg comprises a long edge and a short edge corresponding to a major surface and a minor surface of said leg, and forming a notch at an intersection of the major and the minor surfaces, the notch configured to rotationally stop said leg at a fully extended position.

The method may comprise forming a bevelled face on the distal end of each leg, the bevelled face configured to contact a supporting surface at the fully extended position.

The proximal end of each of the plurality of legs may be connected to the shaft such that the shaft is substantially perpendicular to the support surface at the fully extended position.

The corresponding side surface of the shaft may comprise first and second edges and wherein the proximal end of each of the plurality of legs is connected to the shaft such that the minor surface is adjacent the first edge in the first configuration and the notch abuts the second edge at the fully extended position.

The step of connecting the proximal end of each of the plurality of legs to the shaft may comprise connecting the major surface of each leg to the corresponding side surface of the shaft using a hinge pin.

The method may further comprise connecting a gear mechanism to the plurality of legs, such that the legs are simultaneously operable between the first and the second configurations.

The method may further comprise connecting the gear mechanism to an electric motor.

The step of connecting the gear mechanism may further comprise providing a ratchet configured to rotationally stop the legs at a predetermined angle relative to the shaft.

The step of providing the polygonal shaft may comprise providing a triangular tube, and the step of providing the plurality of legs may comprise providing legs each having a V-shaped cross-sectional profile.

A third aspect of the present invention provides a method of supporting an object on a foldable support assembly. The method comprises providing the foldable support assembly of the first aspect, rotating the legs from the first configuration to the second configuration, and finally to a fully extended position where the legs are rotationally stopped, placing the legs onto a supporting surface, and mounting the object onto the shaft.

### BRIEF DESCRIPTION OF DRAWINGS

Embodiments of the invention will be better understood and readily apparent to one of ordinary skill in the art from the following written description, by way of example only, and in conjunction with the drawings, in which:

FIGS. 1A, 1B and 10 show front perspective views of a foldable support assembly in a compact, a partially extended and a fully extended configuration respectively according to an example embodiment.

FIG. 2 shows a bottom perspective view of the foldable support assembly of FIG. 1 in the compact configuration.

FIG. 3 shows a perspective view of a leg of the foldable support assembly of FIG. 1.

FIG. 4 shows a flowchart illustrating a method of manufacturing a foldable support assembly according to an example embodiment.

FIG. 5 shows a flowchart illustrating a method of supporting an object on a foldable support assembly according to an example embodiment.

Skilled artisans will appreciate that elements in the figures are illustrated for simplicity and clarity and have not necessarily been depicted to scale. For example, the dimensions of some of the elements in the illustrations, block diagrams or flowcharts may be exaggerated in respect to other elements to help to improve understanding of the present embodiments.

### DESCRIPTION OF EMBODIMENTS

The following detailed description is merely exemplary in nature and is not intended to limit the invention or the application and uses of the invention. Furthermore, there is no intention to be bound by any theory presented in the preceding background of the invention or the following detailed description. Herein, a foldable support assembly and method of manufacturing are presented in accordance with present embodiments having the advantages of compactness, enhanced durability, rigidity and improved load-bearing characteristics.

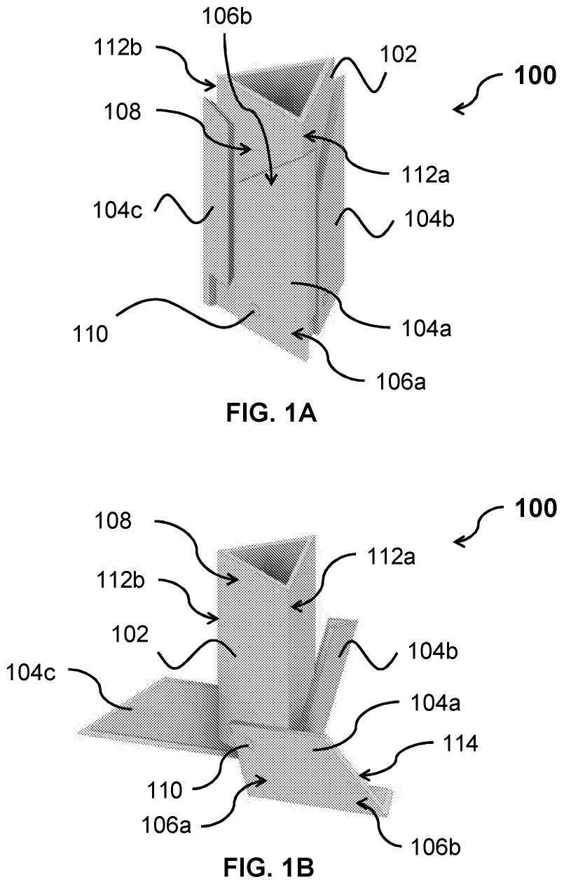

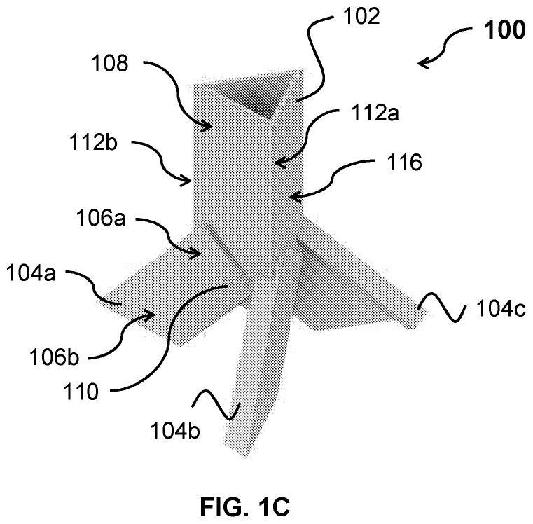

FIGS. 1A, 1B and 10 show front perspective views of a foldable support assembly in a compact, a partially extended and a fully extended configuration respectively according to an example embodiment.

As shown in FIGS. 1A, 1B and 10, the foldable support assembly 100 comprises a hollow triangular shaft 102 and three legs 104a, 104b, 104c arranged around the hollow triangular shaft 102. Each of the three legs 104a, 104b, 104c comprises a proximal end and a distal end, and a cross-sectional profile which is complementary to a cross-sectional profile of the shaft 102. As shown in FIG. 1A, 1B and more evidently in FIG. 3, the legs 104a, 104b, 104c comprises a V-shaped cross-sectional profile which is complementary to the triangular cross-section profile of the shaft 102. The V-shaped cross-sectional profile of the legs 104a, 104b, 104c advantageously allows a compact configuration when the legs 104a, 104b, 104c are folded against the shaft 102. The cross-sectional profile of each of the legs 104 has a long edge 306 (FIG. 3) and a short edge 308 (FIG. 3) which correspond to a major surface 302 (FIG. 3) and a minor surface 304 (FIG. 3) respectively. In the fully extended position as shown in FIG. 10, the long edge 306 which corresponds to the major surface 302 serves as a web member in resisting shear forces that are translated to the leg 104a when the foldable support assembly 100 is subjected to downward and lateral forces. The short edge 308 which corresponds to the minor surface 304 serves as a flange member which resists most of the bending moment experienced by the legs 104a, 104b, 104c. Accordingly, each of the three legs 104a, 104b, 104c forms a unitary body which beneficially adds rigidity to the foldable support assembly 100 when the structure is fully extended as shown in FIG. 10 while maintaining compactness in a folded configuration as shown in FIG. 1A.

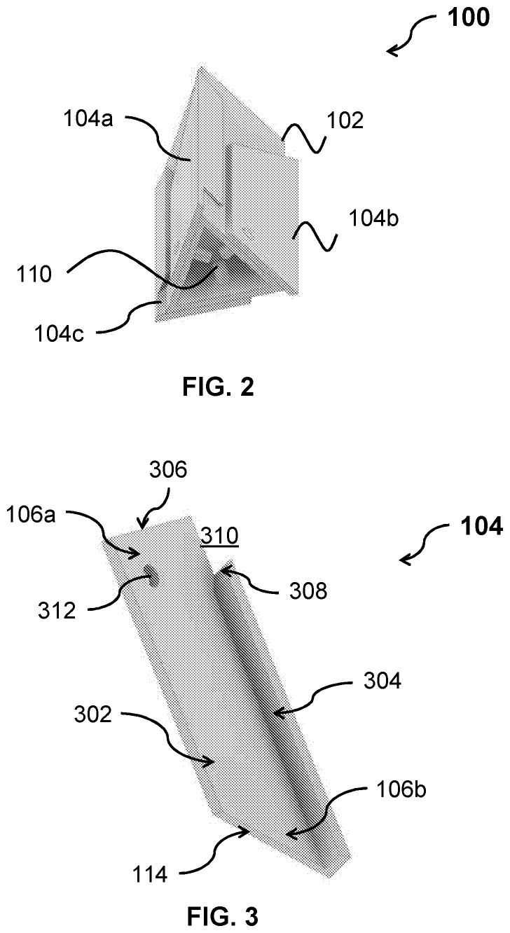

The foldable support assembly 100 also comprises a pivot system which connects the proximal ends of each of the three legs 104a, 104b, 104c to the shaft 102. The pivot system includes a plurality of hinge pins 110, and each of the hinge pins 110 connects the major surface 302 of each of the legs 104a, 104b, 104c to a corresponding side surface of the shaft 102. As shown in FIGS. 1A-2, each of the hinge pins 110 is provided perpendicular to the corresponding surface of the shaft 102 and the major surface of each of the three legs 104a, 104b, 104c. Accordingly, each leg 104a, 104b, 104c is rotatable about an axis perpendicular to the corresponding side surface of the shaft 102. For example, as shown in FIGS. 1A, 1B and 10, leg 104a is rotatable about the central axis of corresponding hinge pin 110.

FIG. 1A shows a compact first configuration where the legs 104a, 104b, 104c are folded against the shaft 102. In the compact configuration, the distal end of each leg 104a, 104b, 104c is adjacent the shaft 102, and a first edge of the corresponding surface is adjacent the minor surface 304. More specifically, using the leg 104a provided in the compact configuration as an example, the major surface 302 (shown in FIG. 3) of the leg 104a is adjacent a corresponding surface 108 of the shaft 102, and first edge 112a of the surface 108 is adjacent to the minor surface 304 (shown in FIG. 3) of the leg 104. The same applies to the each of the legs 106, 108 which are adjacent to respective corresponding surfaces of the shaft 102 (not labelled). The compact configuration is suitable for storage and transportation as the overall size of the assembly is reduced or minimized.

FIG. 1B shows an extended second configuration where the distal end of each leg 104a, 104b, 104c is extended outward from the shaft 102. In the second configuration, each leg 104a, 104b, 104c is rotated at an angle about an axis perpendicular to the corresponding side surface, such that the proximal end of each leg 104a, 104b, 104c is closer to the shaft 102 compared to the distal end. As described in more detail below, in some embodiments, the legs may be configured to move simultaneously from the first configuration to the second configuration. In other embodiments, the legs may move independently of one another.

FIG. 10 shows the fully extended configuration where the legs 104a, 104b, 104c are rotationally stopped at a fully extended position. Each leg 104a, 104b, 104c comprises a notch 310 (as shown in FIG. 3) defined by the major surface 302 and the minor surface 304. At the fully extended configuration, the notch 310 abuts a second edge of the corresponding surface that is parallel to the first edge, thereby stopping the leg 104a, 104b, 104c from further rotation about the hinge axis. For example, in the fully extended configuration, the notch 310 of the leg 104a abuts the second edge 112b of the surface 108, and the notch (not shown) of the leg 104b abuts the first edge 112a, which is also a second edge of the corresponding surface 116. Accordingly, as shown in FIGS. 1A, 1B and 10, each leg 104a, 104b, 104c undergoes a rotation of approximately 225° before being rotationally stopped by the second edge of the corresponding surface of the shaft 102. The notch 310 is integral with the legs 104, 106, 108, and comprises no moving parts. The stopping mechanism for the foldable support assembly 100 is hence beneficially robust and durable, and enables the folding support assembly 100 to be suitable for use in different operating conditions. In the fully extended position, the assembly 100 can be placed on a supporting surface and can be used to support an object. Examples of practical uses include a tripod for cameras and telescopes, and a music stand. It will be appreciated that the degree of rotation by the legs until the fully extended position may be adjusted by adjusting the relative positions of the hinge pin, notch and second edge, etc.

For example, as shown in FIGS. 1A-3, each hinge pin 110 is slotted through a hole 312 provided on the proximal end 106a of each corresponding leg 104a, 104b, 104c. Specifically, the hole 312 is provided near an edge opposite to the notch 310. The placement of the hole 312 away from the notch 310 beneficially increases the range of rotation of the legs 104a, 104b, 104c and allows the distal ends of the legs 104a, 104b, 104c to be positioned further away from the vertical at the fully extended position. The placement of the hole 312 away from the notch 310 also advantageously reduces stress concentrations and effectively increases the durability and strength of the legs 104a, 104b, 104c. Furthermore, in alternative embodiments, various corners and edges of the foldable support assembly 100 can be filleted or rounded, except where they are required to securely engage with other parts. Smoothing of corners and edges also beneficially reduces stress concentrations; enhance durability and aesthetic quality of the assembly 100. The distal end of each leg 104a, 104b, 104c may also comprise a bevelled face 114 configured to contact a support surface upon which the foldable support assembly 100 rests at the fully extended position. The bevelled face 114 of each leg 104a, 104b, 104c can increase the area contacting the support surface to reduce pressure on the contact surface, for example, where the contact surface may be a delicate carpet or grass top, or where the assembly 100 is used on sand or snow. The beveled face may be formed such that the shaft 102 is substantially perpendicular to the support surface at the fully extended position as shown in FIG. 10.

In an alternative embodiment, each of the legs 104a, 104b, 104c may be connected to a gear mechanism (not shown) configured to simultaneously operate the legs 104a, 104b, 104c between the first and the second configurations and through to the fully extended position. For example, with reference to FIG. 2, the gear mechanism may be positioned within the shaft 102, and may comprise a plurality of bevel gears that are connected to each of the hinge pins 110, and each of the hinge pins 110 are integrally connected to each of the legs 104a, 104b, 104c such that when one of the legs 104a, 104b, 104c is rotated, the plurality of gears interact to rotate the other of legs 104, 106, 108. Hence, the gear mechanism can advantageously allow rapid deployment and retraction of the legs 104a, 104b, 104c of the foldable support assembly 100. The gear mechanism may also include a first and a second mode of operation. In the first mode of operation, the plurality of gears engage and interact to rotate the legs 104a, 104b, 104c simultaneously as discussed above. In the second mode of operation, the plurality of gears can be disengaged from each other, such that each leg 104a, 104b, 104c can be rotated individually. The second operation mode can allow each leg 104a, 104b, 104c to be positioned individually, and at dissimilar angles relative to the shaft 102. The second operation mode can advantageously allow the shaft 102 to be positioned vertically on inclined or uneven surfaces. The gear mechanism may be further connected to an electric motor, and may be battery-powered to drive the rotation of the legs 104, 106, 108. The gear mechanism may also include a ratchet (not shown), or a plurality of ratchets (not shown) configured to allow rotation of the gears in one direction, while preventing movement in the opposite direction. The ratchet can therefore be configured to rotationally stop the legs 104a, 104b, 104c at a predetermined angle relative to the shaft 102.

Although the above configuration has been described using three legs and a triangular shaft, it will be appreciated that the scope or configuration of the invention is not intended to be limited in any way. For example, the shaft may comprise four or more sides, and the cross-section of the shaft may not be uniform over its length. Further, the plurality of legs may be less than or equal to the number of sides of the polygonal shaft. For instance, the foldable support assembly may comprise a rectangular shaft with four legs or a hexagonal shaft with three legs arranged evenly around the shaft, such that one side of the hexagonal shaft separates adjacent legs.

In alternative embodiments, the foldable support assembly may comprise an extendable shaft and a plurality of telescopic legs. Each of the telescopic legs may include extendable or foldable sections which increases the height of the foldable support assembly when deployed.

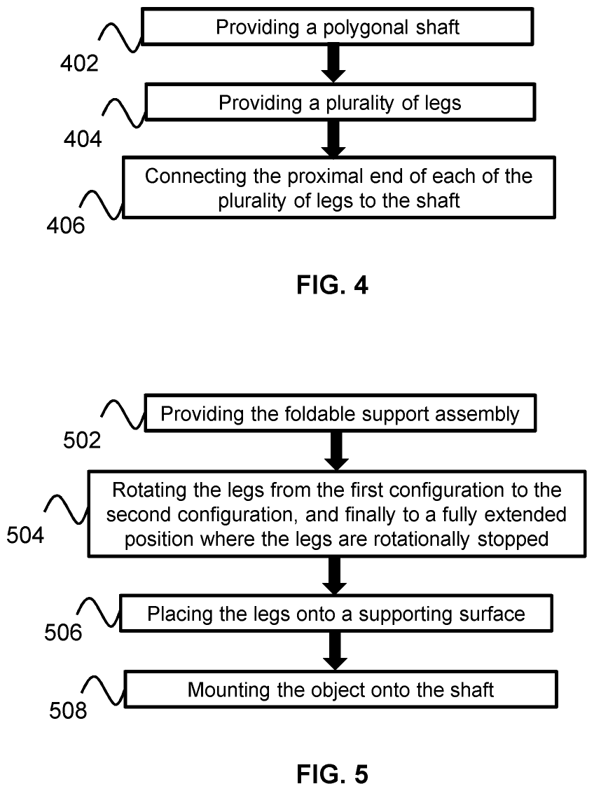

FIG. 4 shows a flowchart illustrating a method of manufacturing a foldable support assembly according to an example embodiment.

At step 402, a polygonal shaft is provided. At step 404, a plurality of legs are provided. Each of the plurality of legs comprises a proximal end and a distal end, and a cross-sectional profile complementary to a cross-sectional profile of the shaft. At step 406, the proximal end of each of the plurality of legs is connected to the shaft such that each leg is rotatable about an axis perpendicular to a corresponding side surface of the shaft. The assembly is thereby operable between a first configuration wherein the distal end of said leg is adjacent the shaft and a second configuration wherein the distal end of said leg extends outwardly from the shaft.

The method of manufacturing the foldable support assembly may also include forming the plurality of legs and forming the polygonal shaft from any one or more of materials: polymers, metals and composites. The polymers may include, but are not limited to polymers which are durable and impact resistant. Examples of polymers include polycarbonates (PC), acrylonitrile butadiene styrene (ABS), polybutylene terephthalate (PBT), polyamide (PA), polyoxymethylene (POM) or combinations thereof. The metals may include, but are not limited to light metals such as aluminium, magnesium, titanium and associated alloys. Stainless steel or low carbon steel may also be used. The composites may include, but are not limited to fibre-reinforced polymers, and fibres contained therein may be glass fibres, carbon fibres or aramid fibres commonly known as Kevlar, Nomex and Technora.

The method of manufacturing the foldable support assembly may also comprise forming the plurality of legs and forming the polygonal shaft from any one or more of processes: extrusion, forging, rolling, injection molding and sintering.

FIG. 5 shows a flowchart illustrating a method of supporting an object on a foldable support assembly according to an example embodiment. At step 502, the foldable support assembly is provided. At step 504, the legs are rotated from the first configuration to the second configuration, and then finally to a fully extended position where the legs are rotationally stopped. At step 506, the legs are placed on a supporting surface and at step 508, the object is mounted onto the shaft.

Thus it can be seen that the foldable support assembly in accordance with the present embodiments have the advantages of robustness, durability, compactness, improved load- bearing characteristics. While exemplary embodiments have been presented in the foregoing detailed description of the invention, it should be appreciated that a vast number of variations exist.

It should further be appreciated that the exemplary embodiments are only examples, and are not intended to limit the scope, applicability, operation, or configuration of the invention in any way. Rather, the foregoing detailed description will provide those skilled in the art with a convenient road map for implementing an exemplary embodiment of the invention, it being understood that various changes may be made in the function and arrangement of elements and method of operation described in an exemplary embodiment without departing from the scope of the invention as set forth in the appended claims.

1. A foldable support assembly comprising:
a polygonal shaft;
a plurality of legs arranged around the shaft, each of the plurality of legs comprising a proximal end and a distal end, and a cross-sectional profile complementary to a cross-sectional profile of the shaft: and
a pivot system connecting the proximal end of each of the plurality of legs to the shaft, such that each leg is rotatable about an axis perpendicular to a corresponding side surface of the shaft to operate the assembly between a first configuration wherein the distal end of said leg is adjacent the shaft and a second configuration wherein the distal end of said leg extends outwardly from the shaft.

2. The foldable support assembly of claim 1, wherein the cross-sectional profile of each leg comprises a long edge and a short edge corresponding to a major surface and a minor surface of the leg, and wherein the major and the minor surfaces define a notch for rotationally stopping the leg at a fully extended position.

3. The foldable support assembly of claim 2, wherein the distal end of each leg comprises a bevelled face configured to contact a supporting surface at the fully extended position, and wherein the shaft is substantially perpendicular to the support surface at the fully extended position,

4. (canceled)

5. The foldable support assembly of claim 2, wherein the corresponding side surface of the shaft comprises first and second edges, and wherein the minor surface is adjacent the first edge in the first configuration and the notch abuts the second edge at the fully extended position.

6. The foldable support assembly of claim 2, wherein the pivot system comprises a plurality of hinge pins, each hinge pin connecting the major surface of each leg to the corresponding side surface of the shaft.

7. The foldable support assembly of claim 1, wherein the plurality of legs are simultaneously operable between the first and the second configurations.

8. The foldable support assembly of claim 7, further comprising a gear mechanism configured to simultaneously operate the legs between the first and the second configurations.

9. The foldable support assembly of claim 8, wherein the gear mechanism is connected to an electric motor.

10. The foldable support assembly of claim 8, wherein the gear mechanism further comprises a ratchet configured to rotationally stop the legs at a predetermined angle relative to the shaft.

11. The foldable support assembly of claim 1, wherein the assembly comprises a tripod, wherein the shaft comprises a triangular tube, and wherein each leg comprises a V-shaped cross-sectional profile.

12. A method of manufacturing a foldable support assembly, the method comprising:
providing a polygonal shaft;
providing a plurality of legs, each of the plurality of legs comprising a proximal end and a distal end, and a cross-sectional profile complementary to a cross-sectional profile of the shaft; and
connecting the proximal end of each of the plurality of legs to the shaft, such that each leg is rotatable about an axis perpendicular to a corresponding side surface of the shaft, the assembly thereby being operable between a first configuration wherein the distal end of said leg is adjacent the shaft and a second configuration wherein the distal end of said leg extends outwardly from the shaft.

13. The method of claim 12, wherein providing the plurality of legs around the shaft comprises:
forming the plurality of legs such that the cross-sectional profile of each leg comprises a long edge and a short edge corresponding to a major surface and a minor surface of said leg; and
forming a notch at an intersection of the major and the minor surfaces, the notch configured to rotationally stop said leg at a fully extended position.

14. The method of claim 13, wherein forming the plurality of legs comprises forming a bevelled face on the distal end of each leg, the bevelled face configured to contact a supporting surface at the fully extended position, and wherein the proximal end of each of the plurality of legs is connected to the shaft such that the shaft is substantially perpendicular to the support surface at the fully extended position.

15. (canceled)

16. The method of claim 13, wherein the corresponding side surface of the shaft comprises first and second edges and wherein the proximal end of each of the plurality of legs is connected to the shaft such that the minor surface is adjacent the first edge in the first configuration and the notch abuts the second edge at the fully extended position.

17. The method of claim 12, wherein connecting the proximal end of each of the plurality of legs to the shaft comprises connecting the major surface of each leg to the corresponding side surface of the shaft using a hinge pin.

18. The method of claim 17, further comprising connecting a gear mechanism to the plurality of legs, such that the legs arc simultaneously operable between the first and the second configurations.

19. The method of claim 18, further comprising connecting the gear mechanism to an electric motor.

20. The method of claim 18, wherein connecting the gear mechanism further comprises providing a ratchet configured to rotationally stop the legs at a predetermined angle relative to the shaft.

21. The method of claim 12, wherein providing the polygonal shaft comprises providing a triangular tube, and wherein providing the plurality of legs comprises providing legs each having a V-shaped cross-sectional profile.

22. A method of supporting an object on a foldable support assembly, the method comprising:
providing the foldable support assembly as claimed in claim 1;
rotating the legs from the first configuration to the second configuration, and finally to a fully extended position where the legs arc rotationally stopped:
placing the legs onto a supporting surface; and
mounting the object onto the shaft.
